(19) United States
(12) Patent Application Publication
(10) Pub. No.: US 2011/0109472 A1
(43) Pub. Date: May 12, 2011

(54) RESOURCE MONITORING ON A MOBILE DEVICE

(75) Inventors: Charles S. Spirakis, Mountain View, CA (US); Russell S. Heywood, Santa Clara, CA (US); Don T. Vo, San Jose, CA (US); Edward T. Lu, Saratoga, CA (US)

(73) Assignee: GOOGLE INC., Mountain View, CA (US)

(21) Appl. No.: 12/847,882

(22) Filed: Jul. 30, 2010

Related U.S. Application Data
(60) Provisional application No. 61/230,075, filed on Jul. 30, 2009.

(51) Int. Cl. G08C 15/06

(52) U.S. Cl. 340/870.02; 340/870.07

(57) ABSTRACT

A first set of data reflects usage of a resource based on readings from a metering device located at a first user's premises. A second set of data reflects usage of the resource at multiple other user premises. Comparison and usage indicators are generated based one the first and second sets of data. A comparison indicator is generated based on the first set of data and the second set of data. A usage indicator is generated based on the first set of data. The usage indicator reflects the usage of the resource at the first user's premises over a period of time and the comparison indicator reflects the same usage relative to the usage at the multiple user premises over the same period of time. The comparison indicator and the usage indicator are sent to a mobile device that displays the indicators.

### CROSS-REFERENCE TO RELATED APPLICATIONS

This application claims priority from U.S. Provisional Application Ser. No. 61/230,075, filed on Jul. 30, 2009, which is incorporated herein by reference in its entirety.

### TECHNICAL FIELD

This document relates to tracking usage of a resource on a mobile device.

### BACKGROUND

Energy monitoring devices such as smart meters are used, usually at customer premises, for monitoring consumption of a utility resource, such as electricity, natural gas or water. Smart meters typically record usage readings at certain intervals and provide the information as feedback to the utility company supplying the resource. In general, smart meters provide a two way communication between customers and their utility companies.

### SUMMARY

In one aspect, a method includes accessing, at a server system, a first set of data reflecting usage of a resource at a first user's premises. The first set of data is based on readings from a metering device at the first user's premises. The server system is at a location that is different than a location of the first user's premises. The method also includes accessing, at the server system, a second set of data reflecting usage of the resource at multiple other user premises. The method further includes generating a comparison indicator and a usage indicator. The usage indicator reflects the usage of the resource at the first user's premises over a period of time and the comparison indicator reflects the same usage relative to the usage of the resource at the multiple user premises over the same period of time. The comparison indicator is generated at the server system based on the first set of data and the second set of data. The usage indicator is also generated at the server system based on the first set of data. The method further includes sending the comparison indicator and the usage indicator from the server system to a mobile device that displays the comparison indicator and the usage indicator.

In another aspect, the application features a computer-readable medium storing a computer program. The computer program includes instructions that, when executed by one or more processing devices, cause the one or more processing devices to access a first set of data that reflects the usage of a resource at a first user's premises. The first set of data is based on readings from a metering device at the first user's premises. The one or more processing devices are at a location that is different than a location of the first user's premises. The instructions also cause the one or more processing devices to access a second set of data that reflects usage of the resource at multiple other user premises. A comparison indicator is generated based on the first set of data and the second set of data. The comparison indicator reflects the usage of the resource at the first user's premises over a period of time relative to the usage of the resource at the multiple other user premises over the same period of time. A usage indicator is also generated, based on the first set of data, and reflects the usage of the resource at the first user's premises over the period of time. The comparison indicator and the usage indicator are sent to a mobile device that displays the comparison indicator and the usage indicator.

In another aspect, a system includes a server system and a mobile device. The server system is configured to access a first set of data that reflects the usage of a resource at a first user's premises and a second set of data that reflects the usage of the resource at multiple other user premises. The first set of data is based on readings from a metering device located at the first user's premises. The server system is located at a location that is different than a location of the first user's premises. The server system generates a comparison indicator and a usage indicator. The comparison indicator is generated based on the first set of data and the second set of data and reflects the usage of the resource at the first user's premises over a period of time relative to the usage of the resource at the multiple user premises over the same period of time. The usage indicator is generated based on the first set of data and reflects the usage of the resource at the first user's premises over the period of time. The mobile device is configured to receive and display the comparison indicator and the usage indicator transmitted by the server.

Implementations may include one or more of the following features. For example, the resource can be electricity. The readings from the metering device located at the first user's premises can include periodic readings of a quantity of the resource consumed at the first user's premises. The first set of data can be processed to generate one or more indications of a quantity of the resource consumed between the periodic readings. Processing the first set of data can include interpolating between the periodic readings to generate the one or more indications. The second set of data can be based on readings from metering devices located at the multiple other user premises. The multiple other user premises can be located within a defined geographic area, such as an area with the same zip code. The metering device can be installed and operated either by the first user or by a company providing the resource to the first user's premises. The server system can calculate, based on the first data, a baseline usage of the resource and send a representation of the baseline to the mobile device that displays the baseline.

The server system can receive a total target amount of usage of the resource at the first user's premises over a predetermined future time period. The first user can select the total target amount using an interface of the mobile device. The server can track an actual usage of the resource at the first user's premises over a portion of the predetermined time period and generate a goal indicator that reflects a comparison of the actual usage to the total target amount of usage. The goal indicator can be sent to the mobile device to be displayed on the mobile device. The server system can receive information identifying a group of users selected by the first user. The selection can be made using the interface of the mobile device, and the total target amount of usage can be a predetermined percentage of a representative usage of the resource at the selected users' premises over a time period substantially equal to the predetermined future time period.

The server system can receive information identifying a first group of users selected by the first user using an interface on the mobile device. The data on usage of the resource at the premises of the selected group of users can be used as the second set of data. The server can also receive information identifying a second group of users selected by the first user using the interface on the mobile device and access a third set of data reflecting the usage of the resource at user premises for the second group of users. An updated comparison indicator can be generated at the server system based on the first set of data and the third set of data. The updated comparison indicator can reflect the usage of the resource at the first user's premises over a period of time relative to the usage of the resource at the user premises for the second group of users over the same period of time. The updated comparison indicator can be sent from the server system and to the mobile device such that the mobile device displays the updated comparison indicator and the usage indicator.

The server system can be operated by a third party independent from a utility company providing the resource. The server system can receive the first set of data reflecting usage of a resource at a first user's premises from the utility company. The server system can also receive the first set of data directly from the metering device located at the first user's premises.

The mobile device can be configured to accept from the first user, via a user interface, information identifying a group of users such that usage data of the resource at premises of the group of users is used as the second set of data. The mobile device can be further configured to accept from the first user, via a user interface, information identifying a second group of users selected by the first user. The mobile device can send an indication of the second group of users to the server system. The mobile device can be configured to accept, from the first user, via a user interface, a total target amount of usage of the resource at the first user's premises over a predetermined future time period. The mobile device can be further configured to accept from the first user, via a user interface, information identifying a group of users such that the total target amount of usage is a predetermined percentage of a representative usage of the resource at premises of the group of users.

The server system can be configured to access a third set of data that reflects the usage of the resource at user premises for the second group of users, and generate, based on the first set of data and the third set of data, an updated comparison indicator. The updated comparison indicator reflects the usage of the resource at the first user's premises over a period of time relative to the usage of the resource at the user premises for the second group of users over the same period of time. The server system is further configured to send, to the mobile device, the updated comparison indicator such that the mobile device displays the updated comparison indicator and the usage indicator.

Implementations of the techniques described in this document may offer several advantages. For example, real-time or at least near real-time monitoring of resource consumption may help a user to identify if too much of the resource is being consumed at a given time. Having the real time usage data available on a mobile device may allow a user to monitor usage of the resource even when the user is not located at his or her premises and, potentially, may allow the user to take appropriate steps irrespective of the physical location of the user. Such monitoring may also help identify power usage patterns and, as a result, help a user reduce consumption, especially at peak times when power is expansive and/or limited in supply. In some cases, when the consumption of the user is displayed in comparison with other users, the user may be encouraged to put effort in reducing the consumption.

Implementations of the described techniques may include hardware, a method or process, or computer software on a computer-accessible medium. The details of one or more implementations are set forth in the accompanying drawings and the description below. Other features and advantages will be apparent from the following detailed description, and from the claims.

### BRIEF DESCRIPTION OF THE DRAWINGS

FIG. 1 is a schematic diagram showing an example of a communication system that provides resource monitoring.

FIG. 2 is a schematic diagram showing an example of a system for resource monitoring.

FIG. 3 is a flow diagram of an example of a process to deliver resource monitoring data.

FIG. 4 is a schematic representation of an example of a mobile device.

FIG. 5 is a block diagram illustrating an example of an internal architecture of the device of FIG. 4.

FIGS. 6A-6D are illustrations showing examples of user interfaces for resource monitoring on a mobile device.

FIG. 7 is an illustration showing an example of a computing device.

### DETAILED DESCRIPTION

Smart meters are used for providing information on usage of a resource, for example electrical power, water, gas, propane, fuel oil or heat, at a user's premises. In some cases, the information is provided to the utility company providing the resource. It could be of interest in such cases, for example due to various regulatory and financial reasons, for a utility company to make the usage information readily accessible to the user. In some cases, a user may be interested in installing a smart meter and accessing the information provided by the smart meter from a remote location. By appropriately storing and processing usage information received from a smart meter, the information can be made readily available to a user, for example via a user interface on a mobile device of the user. In some cases, a comparison of the usage information to that of other users, can also be displayed. Such information can encourage the user to reduce the usage, especially in comparison to the usage of other users.

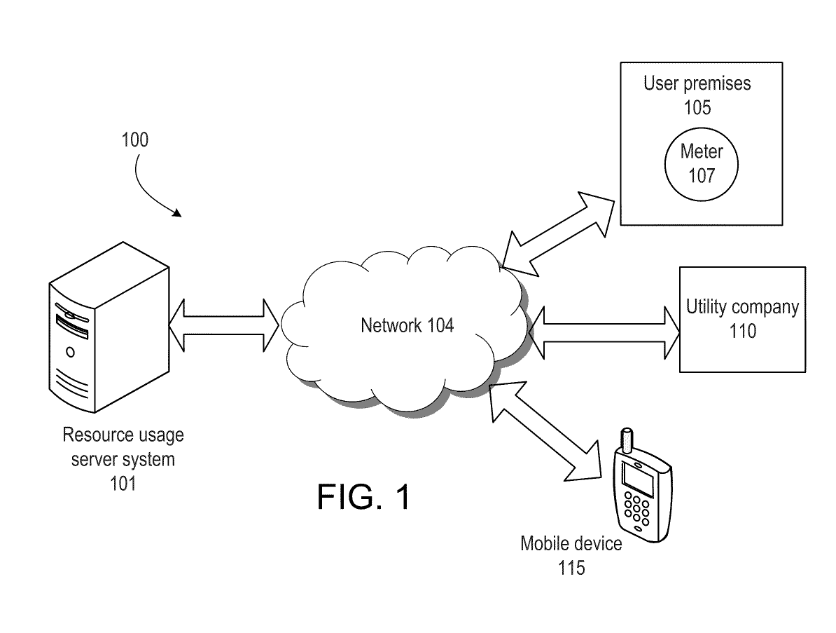

FIG. 1 is a schematic diagram showing an example of a communication system 100 that provides resource monitoring. The system 100 includes a resource usage server system 101 in communication over a network 104 (for example, the Internet) with a meter 107 in user premises 105. The system also includes an utility company 110 (or devices therein) and a mobile device 115 connected to the network 104. In general, the meter 107 transmits usage information to the server system 101, either directly or through the utility company 110, which processes and stores the information. While a single utility company 110 is shown, there could be a plurality of utility companies, providing the same or other resources, within the system 100. A user can access and view the information using a device, such as the mobile device 115, that communicates with the server system 101.

In general, the meter 107 is installed at the user premises 105. The user premises 105 can be any facility or location where utility resources are used. For example, the user premises 105 can be a residential facility such as a house or an apartment. The user premises 105 can also be a business establishment or commercial institution. In general, the meter 107 is a smart meter capable of measuring or monitoring consumption of a resource at the user premises 105 and transmitting the measurements over the network 104. In some implementations, the monitored resource is electricity (or electrical power) and the meter 107 allows measurement of power usage at predefined intervals of time. Alternatively, or additionally, the monitored resource can be other resources consumed at the premises, such as natural gas, propane, fuel oil, water and heat.

In some implementations, the meter 107 transmits measurements or data reflecting usage directly to the server system 101 over the network 104. In other implementations, the meter 107 transmits the data to the utility company 110 over the network 104 (or another network). The utility company 110 stores the data, for example, for its own purposes and transmits the data to the server system 101 over the network 104.

The meter 107 can be either be user-installed or provided by the utility company 110 supplying the particular resource. For example, a user can buy a suitably equipped meter 107, such as ones available from Current Cost of United Kingdom or Energy Inc. of Charleston S.C. Such user-installed meters may monitor the resource usage and may transmit the information directly to the server system 101. In some cases, the user-installed meters can supplement a smart meter provided by the utility company. For example, the utility company may provide a meter to monitor the overall electricity usage while one or more user installed meter(s) may monitor individual appliances or devices.

In some implementations, the utility company 110 enters into an arrangement with a third party to provide the data from the meter 107 to an external server system 101, which is owned by the third party. In other implementations, the utility company 110 can own and operate the server system 101. In some implementations, a third party server system can be configured to receive consumption information on a plurality of resources (water, power, natural gas, propane, fuel oil, heat etc.), either directly from the user's premises or via the corresponding utility company, and provide a unified interface (for example, on a mobile device) that allows the user to monitor all the resources from the same interface.

The meter 107 may measure the consumption of the resource at pre-defined time points or intervals. For example, the meter 107 may measure the consumption after every fifteen minutes or half-hour. In some implementations, the meter may be configured to record a measurement on detecting an event such as a load change exceeding a predetermined threshold. The meter 107 may provide a time-stamped series of meter values that represent real-time or near real-time consumption level of the resource being monitored. The meter values can either be absolute values, such as instantaneous meter readings at the time of measurement, or incremental usage data, i.e. the total amount consumed since the last reading.

The resource usage server system 101 receives and at least temporarily stores the consumption data received from the meter 107. The server system 101 processes the consumption data from a particular user to generate visual displays of the resource usage at the user's premises 105. The server system 101 can also process usage data from other users and generate comparison information. The data generated at the server system 101 is configured to be displayed on the mobile device 115. In some implementations, the server system 101 may be a single server while in other implementations, the server system 101 may include multiple, logically-grouped servers. The logical group of servers may be referred to as a server farm or data center. The servers in such a logical group may be geographically dispersed. In some implementations, the server farm may further comprise a plurality of server farms.

The servers 101 within each farm may be heterogeneous. One or more of the servers 101 may operate according to one type of operating system platform (e.g., WINDOWS NT, manufactured by Microsoft Corp. of Redmond, Wash.), while one or more of the other servers 101 may operate on according to another type of operating system platform (e.g., Unix or Linux). The group of servers logically grouped as a farm may be interconnected using a wide-area network (WAN) connection or medium-area network (MAN) connection. For example, a farm may include servers 101 physically located in different continents or different regions of a continent, country, state, city, campus, or room.

The server system 101 may function as a file server, application server, proxy server, or gateway server. In some implementation, the server system 101 provides functionality of a web server. In some implementations, a communicating device, such as the mobile device 115 may execute an application to communicate with the server system 101.

The mobile device 115 can be any wireless device capable of communicating with the server system 101 over a network, for example the internet. The mobile device can be a mobile phone, a smart phone, a personal digital assistant (PDA) or a Wi-Fi enabled device that can run web-based applications.

The network 104 may include one or more different types of network. For example, the network 104 may include a local area network (LAN), such as a company intranet or a home network. In some implementations, the network 104 may include a metropolitan area network (MAN) or a wide area network (WAN) such as the Internet. In other implementations, the network 104 may include a combination of one or more different types of network. For example, a LAN such as the home network may be connected to an external access network. In such cases, one or more gateway devices may act as interfaces between two different networks.

The network 104 can be of any type and form and may include any of the following: a point to point network, a broadcast network, a computer network, a power line network, an Asynchronous Transfer Mode (ATM) network, a Synchronous Optical Network (SONET), a Synchronous Digital Hierarchy (SDH) network, a wireless network and a wired network. If the network 104 is at least in part a wired network, the network 104 may include one or more of the following: coaxial cable, telephone wires, power line wires, twisted pair wires or any other form and type of wire. The topology of the network 104 may be a bus, star or a ring topology or other topology capable of supporting the operations described herein.

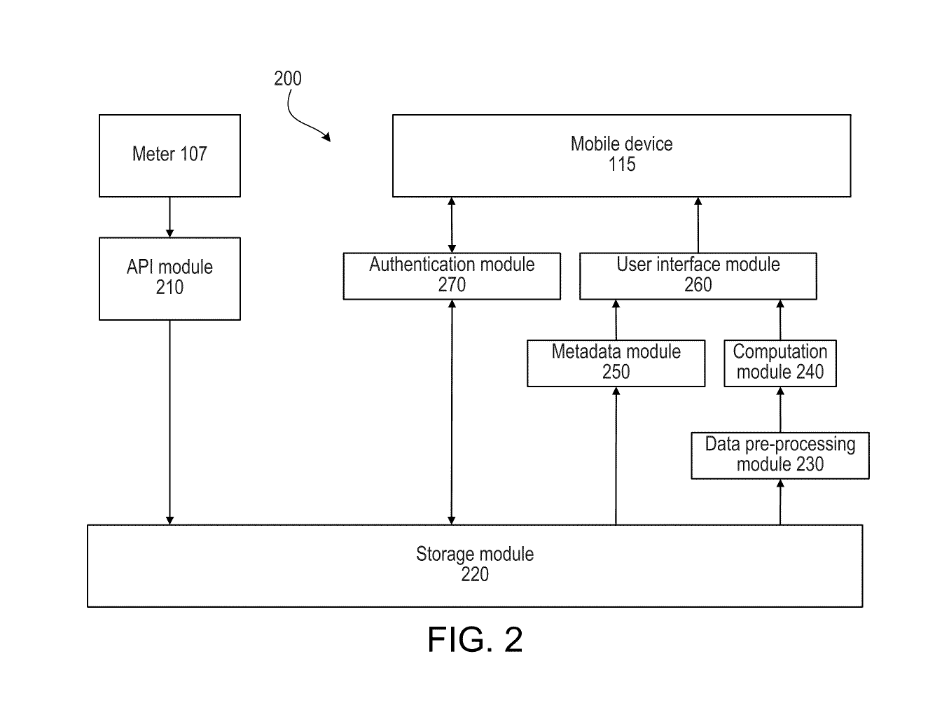

FIG. 2 is a schematic diagram showing an example of a system 200 for resource monitoring. The system 200 includes a meter 107 and a mobile device 115 in communication with various other modules implemented, for example, by server system 101. For example, the meter 107 can communicate with the storage module 220 through an application programming interface (API) module 210. In some implementations, the meter 107 can communicate with the API module 210 using a secure protocol, for example, a secure hypertext transfer protocol (HTTPS). The meter 107 can transmit the recorded meter readings as well as account information to the API module 210. The account information may be transmitted as metadata accompanying the meter readings.

In some implementations, the API module 210 is implemented as a software module executing on a server or group of servers. For example, the API module 210 may be implemented and/or executed on the server system 101. In some implementations, the API module 210 provides an application programming interface (API), which the meter 107 uses to transmit the meter readings or other data reflecting usage of the resource. The API module 210 may be implemented using an object oriented programming language such as Java or non object oriented programming languages such as C. Constructs appropriate to the programming language, such as Java servlets in the current example, can be used in the implementation of the API module 210.

In some implementations, the meter readings and meta data information, after being processed by the API module 210, are sent to a storage module 220. In some implementations, access to the storage module 220 is monitored and/or controlled using an access control mechanism such as a data access object (DAO). In general, such access control mechanism provides an API to the storage module 220. Entities accessing the storage module 220 (for example, resource providing companies or resource users) can have restricted access to the storage module 220 through the access control mechanism. For example, a resource providing company can create, read and/or modify account information for only the accounts that are provided or owned by the company. In such cases, the company can store resource consumption measurements only for the channels or accounts that they provide the resource to. Similarly, the access control mechanism ensures that a user can access and possibly modify account information related only to their own accounts. The access control mechanism can also be used to provide further control over the stored data. In some implementations, a provider company can have the access control mechanism configured such that a user can edit only a portion of the account information. For example, a user may have permissions to view the account information without being able to modify or edit any measurements stored in the storage module 220. The access control mechanism can interact with the storage module 220 using remote procedure calls.

The storage module 220 may include any number of servers and computing devices based on the volume of data being stored. The storage module may be physically and/or logically grouped into various storage units and could be managed by a database management system. For example, the storage module may be implemented using a distributed storage system. Such large scale storage schema and management allows the storage module 220 to be accessed by a large number of users.

The data stored at the storage module 220 is used to generate user interface that includes various data related to the consumption of a resource at the user's premises, which is provided to the mobile device 115 for display on the mobile device 115. To receive such an interface, the mobile device may first provide authentication information to authentication module 270. The authentication module 270 authenticates the user, and then provides the mobile device 115 with access to an interface generated based on the user's associated data. In some implementations, the user can provide authentication credentials, such as a username/password combination, to an application executing on the mobile device 115. The application, in turn, provides the information to the authentication module 270, which authenticates the mobile device 115 to access the desired information. In some implementations, once the mobile device 115 is authenticated, the authentication module 270 passes an access token back to the application. The application can use the access token to retrieve the desired information. The application on the mobile device 115 may be a web browser and the authentication module 270 may be implemented as a trusted website that provides secure handling of the user's credentials. In some implementations, using such an authentication module for authentication obviates the need to provide the user credentials to a third party application executing on the mobile device 115.

In some implementations, the operating system of the mobile device 115 can be configured to open a browser from a separate application to access the authentication module 270 and relaunch the application upon successful authentication. In some implementations, a web-view (for example a mini-browser) can be launched within the application to access the authentication module 270. In some implementations, the authentication module 270 also facilitates an enrollment process, for example registering a given meter 107 with a user or a mobile device 115.

Upon authentication, a user can retrieve and view, on the mobile device 115, data related to the usage of the resource at the user's premises. The information is included in an interface or resource use display generated by the user interface module 260, and the interface is sent to the mobile device 115 such that the resource use display is rendered or displayed on the mobile device 115. The interface rendered on the mobile device 115 can be a graphical user interface (GUI) or some other interface capable of presenting information to a user in a meaningful way. For example, the interface may provide an audible read-out of information, which can be useful to users with visual disabilities.

In general, the user interface module 260 receives information and/or data from the computation module 240 and the metadata module 250 and generates a resource use display suitable for displaying on the mobile device 115. The resource use display can include various data (for example in tabular or graphical form) related to the consumption of a resource (for example, electrical power) at the user's premises. For example, the resource use display can include overview charts of resource usage over a period of time, such as the last day, month, or year. The resource use display can also include estimated energy costs and comparisons to the same time period from last year.

In some implementations, the resource use display provides a comparison of a user's consumption over a period of time relative to a representative consumption of other users within a predefined group and over a substantially same period of time. For example, the user interface module 260 can provide information on how a user's consumption per day compares to the average daily consumption of other similar sized households. Additionally, or alternatively, the comparison group may include users or households within a defined geographic region, such as those in the same zip code as the user, or the same region of the country (for example, the Northeast United States). Thus, for example, the group may be similar sized households within the same zip code as the user.

In some implementations, the user interface module 260 can provide information on a user's consumption in comparison to a friend's (or group's) consumption provided the friend (or group) agrees to share information with the user. In some implementations, a user, using an interface on a mobile device, can select the friends to be included in a group. Using the interface on the mobile device, the user may also be able to perform various manipulations on the selected group of friends. For example, the user may provide or rescind permission to share the user's data with a selected friend. The user may also create and edit sub-groups within a selected group of friends. In some implementations, a user may be able to choose different subgroups for different times of the year (or month or day) to be compared to. For example, the user may use the mobile device interface to choose a first subgroup of friends to receive comparison data in the summer and a second subgroup to receive comparison data in the winter. In some implementations, the user may also be able to choose different subgroups to be compared to for different resources. For example, the user may choose, via the mobile device interface, for the user's water consumption to be compared to a first group of friends and the user's electrical power consumption to be compared to a second group of friends. In some cases, for example when a user owns multiple accounts for multiple premises, the user may be able to select different groups or subgroups of friends separately for each account, possibly using the same interface on the mobile device.

In addition, the user interface on the mobile device may allow the user to dynamically select the group that the user is being compared to, and the user interface module 260 will update the display in response to the new selection. For example, the user may first select other households in the same zip code a the user, at which point the user interface module 260 causes the display on the mobile device to display a comparison indicator that indicates the user's consumption relative to other households in the same zip code. The user then may use the interface on the mobile device to select a particular group of friends and, in response to that selection, the interface module 260 causes the display on the mobile device to display a comparison indicator that indicates the user's consumption relative to the selected group of friends.

In some implementations, the user interface module 260 can generate the resource use display in multiple selectable formats. For example, a user may be able to switch between a summary view and a detailed view. The detailed view can have additional fields and display parameters compared to that of the summary view. For example, the summary view can show overview charts of usage over the last day, month, and year, with estimated energy costs and comparison to the same time period last year while the detailed view can show a detailed interactive chart of all usage data, with estimated energy costs and estimated carbon emission equivalents. The detailed view can include fields in addition to the fields shown in the summary view. In some implementations, the user interface module 260 can generate several separate views or pages linked with one another. For example, one particular view or page can be used to accept user preferences while a second view can be used for displaying the data. In this example, a third view may be used to show a comparison with other users. In general, the user interface module 260 links the different views or pages with one another and/or to a home page or view, for example via hyperlinks.

Various types and forms of information are provided by the user interface module 260 in the resource use display. For example, in the case of monitoring electrical power usage, the resource use display can include daily usage information such as total kWh used (for example, since 12 AM), total cost (for example, since 12 AM), percentage difference compared to the same day last year, total kWh used the previous day, total cost incurred the previous day and percentage difference compared to the same day 2 years ago. Similarly, the resource use display can also include monthly usage information such as: total kWh used since beginning of the month, total cost incurred since beginning of the month, percentage difference compared to the same date range from the previous year, total kWh used the previous month, total cost incurred the previous month, and percentage difference of the previous month compared to the same month last year. The resource use display can also include yearly usage information such as: total kWh used since January 1^{st}, total cost incurred since January 1st, percentage difference compared to the same date range last year, percentage difference compared to same date range 2 years ago, total kWh used last year during the same date range, and total cost last year. In some implementations, the user interface module 260 can also include, in the resource use display, any of the following information: a current meter reading, an estimated reading or cost for a future time period, total resource consumed (or total cost) across several meters owned by a user, and comparison of usage (and/or cost) to another date range or to a predefined group of users (for example, all users, or selected friends).

In some implementations, the user interface 260 can include in the resource use display, a goal or pledge (for example, selected by a user) to achieve over a given time period. For example, the user interface module 260 can include in the resource use display that the user has set a goal of using less than a selected amount of the resource in a given month. In another example, the user can pledge to achieve lower carbon emissions than a selected value. The user interface module 260 can include in the resource use display the one or more pledges or goals of the user along with a pledge performance status. For example, the user interface module 260 can include in the resource use display how well or badly the user performs in achieving the set goal. If a user pledges to use a predefined amount of resource in a given month and spends half of the predetermined amount in a week, the user interface module 260 can include in the resource use display, an indication, either qualitative (for example, a phrase such as “try harder”) or quantitative (for example, a probability value of achieving the goal), that the user is not on track to achieve the goal. In some implementations, the user interface module 260 can also include suggestions or analyses in the resource use display to help the user modify the usage in order to achieve the goal. In some implementations, the user interface module 260 can include a link in the resource use display, to launch a goal or pledge management module as a separate application or webpage. In some implementations, a user may be able to select, via an interface on a mobile device, a particular group or sub-group of friends, and select a goal or pledge based on the consumption and/or pledge information of the selected group or subgroup of friends. In other words, the user may set a goal that is based on the consumption of a group of friends (for example, a goal of using 50% less than the group of friends).

In some implementations, the resource use display can also feature community pledges. For example, the user interface module 260 can include in the resource use display, a list of pledges made by other users and how well the other users are doing in achieving their respective goals. In some implementations, the resource use display can feature an interface to select a subset of users who have made pledges or set goals. In such cases, once a user has selected a subset of other users, the user interface module 260 includes in the resource use display, the pledge information for only the subset selected by the user.

In case of monitoring electrical power consumption, the user interface module 260 can also display estimated carbon emissions based on the usage data. The carbon emission data can also be displayed as a comparison to other carbon emission activities.

The user interface module 260 interacts with one or more of a computation module 240 and a metadata module 250 to obtain information for generating the resource use display. In some implementations, the computation module 240 and/or the metadata module 250 retrieves the information from the storage module 220 and provides the information to the user interface module 260. In some implementations, a data-interchange format such as JavaScript Object Notation (JSON) is used to facilitate the information exchange. In such cases, the requests from the user interface module 260 are handled by a request class such as the Java class JsonRequest, while the responses are handled by a response class such as the Java class JsonResponse.

A request class typically includes several fields such as statistic-specific fields, usage specific fields and miscellaneous fields including a request type (for example, consumption values, rates, percentiles etc.), a response format (e.g., specifying that the response should be in JsonResponse), one or more units (e.g., power in KWH and time in minutes) and one or more variables indicating a subject of a query. The statistic-specific fields can include, for example, an upper bound on the start date of a date range used for calculating a statistic, duration over which a percentile value is computed, and groups (of other users) used in comparison analyses. The usage specific fields can include, for example, graph features (e.g., showing a baseline usage and peaks on graphs of usage rate v. time), variable combinations, and interval sizes or sampling frequencies for display (e.g. day, week, month etc.).

A response class typically includes one or more of a response code, one or more data streams (usually one stream for each variable in the corresponding request), statistics (for example, percentile values) and time data. The time data is usually provided both in absolute time (for example in milliseconds since a predetermined time point) as well as in the local time. The time data can also include a last measurement time and start and end times of the interval covered.

In general, raw data from the storage module 220 is processed before being provided to the user interface module 260 on the mobile device 115. For example, data from the storage module 230 can be processed by a data pre-processing module 230. In general, the data preprocessing module 230 prepares the data for computations by the computation module 240. For example, the raw data from the storage module 230 can be unevenly spaced or missing for some data points. In some implementations, the pre-processing module 230 performs interpolation from the available data points to have an evenly spaced set of points at desired time points. For example, a request may ask for information on usage pattern with 5 minute resolution while the raw data is available only at 15 minute intervals. In such cases, the data pre-processing module 230 interpolates two extra points between the available data points and prepares the data for subsequent processing by the computation module 240. The data pre-processing module 230 can use data on prior usage to prepare the data. For example, for the interpolations, the pre-processing module 230 can choose between linear interpolation and non-liner curve fitting, based on prior usage data from the same time range on other days.

The computation module 240 processes the data points to produce information that can be used by the user interface module 260 to produce the resource use display. In general, the computation module 260 can perform the necessary computations to produce information that is described above with respect to the user interface module 260. In some implementations, a metadata module 250 retrieves metadata information from the storage module 250 and transmits the metadata information to the user interface module 260. The metadata information can include additional information such as information about the user's list of accounts and the variables. For example, if a user has two separate accounts (for example, because of having two houses), the metadata identifies the correct account for which the user interface module 260 receives data from the computation module 240. In general, the metadata information provides contextual information for the information received from the computation module 240.

In some implementations, the various modules described above can be implemented in a centralized data center such as a server system 101. In some implementations, the modules may be implemented in physically diverse locations, for example in a server farm where the servers are geographically separated. In some implementations, some of the modules may be implemented in one location while the others are implemented in a separate location. For example, the API module 210, the metadata module 250, the computation module 240 and the data pre-processing module can be implemented in one server while the storage module can be in a different server or group of servers. In some implementations, the user interface module 260 is implemented in a server system and the generated resource use display is sent to the mobile device 115. In other implementations, at least a portion of the user interface module 260 can be implemented on the mobile device 115.

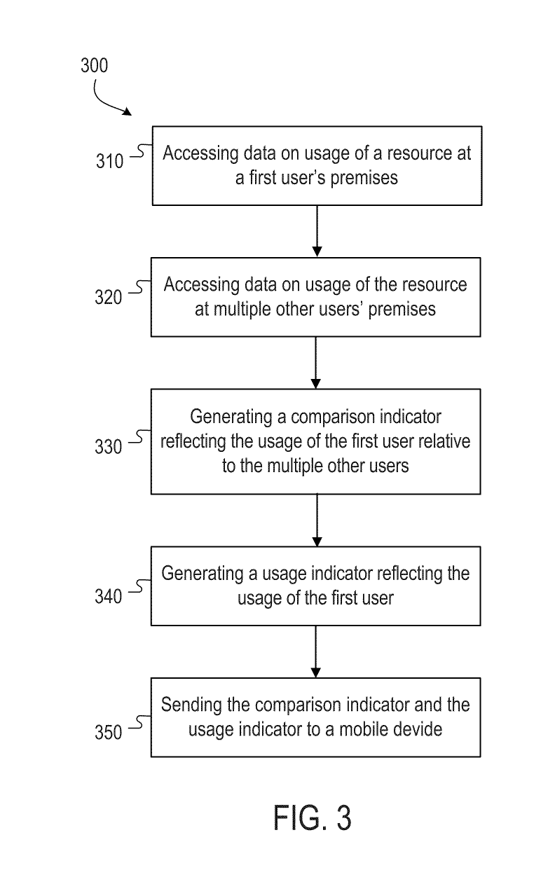

FIG. 3 is a flow diagram 300 of an example of a process to deliver resource monitoring data. Operations include accessing data on usage of a resource at a first user's premises (310). In general, the data is based on readings from a metering device located at the first user's premises. The server system is typically located at a remote location from the user's premises. The metering device is capable of establishing a communication link with and transmitting data to the remote server. In some implementations, data from the metering device is stored on a storage device and accessed by the server. In some implementations the metering device and the server system are substantially similar to the meter 107 and server system 101, respectively.

Operations also include accessing data on usage of the resource at the premises of multiple other users (320). The multiple other users typically do not include the first user. The other users can include other subscribers of the resource who share some common characteristic with the first user. For example, the other users can be subscribers within a same area or subscribers with a substantially similar sized house or family. The other users can also be selected by the first user. For example, the other users can be a group of friends of the first user who agrees to share their usage data with the first user. The data on the usage of the other users are recorded and transmitted by corresponding metering devices which may be substantially similar to the metering device of the first user. In some implementations, the usage data of the other users are stored at a storage location and accessed by the server.

Operations further include generating a comparison indicator reflecting the usage of the first user relative to the multiple other users (330). The comparison indicator is generated at the server system based on the usage data of the first user over a period of time and that of the multiple other users over a substantially same or similar period of time. Generating the comparison indicator can include computing a statistic on the usage data of the other users. Such a statistic can include, for example, an average consumption of the multiple users over the period of time being considered or a maximum (or minimum) consumption over the period of time. The comparison indicator can include, for example, a deviation from the average usage of the other users or a percentile with respect to the other users. For example, the comparison indicator can indicate what percentage of users are using more resource than the first user. The comparison indicator can also indicate, for example, a percentage difference of the first user's usage from the average usage of the other users. The comparison indicator may include textual information, for example a number such as a percentage deviation, graphical information or both.

Operations also include generating a usage indicator reflecting the usage of the first user (340). The usage indicator can be, for example, a metric indicating the total amount of resource used at the first user's premises. In some implementations, the usage indicator can include a breakdown of the usage by different devices at the first user's premises. In some implementations, the usage indicator can include a baseline usage, i.e. a minimum amount of the resource used by the first user at all times. For example, in case of electrical power usage, the baseline usage can be due to some devices or gadgets such as a refrigerator, that remain switched on at all times. The usage indicator can include textual information, graphical information, or both.

Operations can also include sending the comparison indicator and the usage indicator to a mobile device such that these indicators are displayed on the mobile device (350). In some implementations, a server sends such information to the mobile device in response to a request from the mobile device. In some implementations, the information is sent via a secure communication channel established between the server and the mobile device. In some implementations, other information such as metadata identifying account information of a user may also be sent in addition to the comparison indicator and usage indicator.

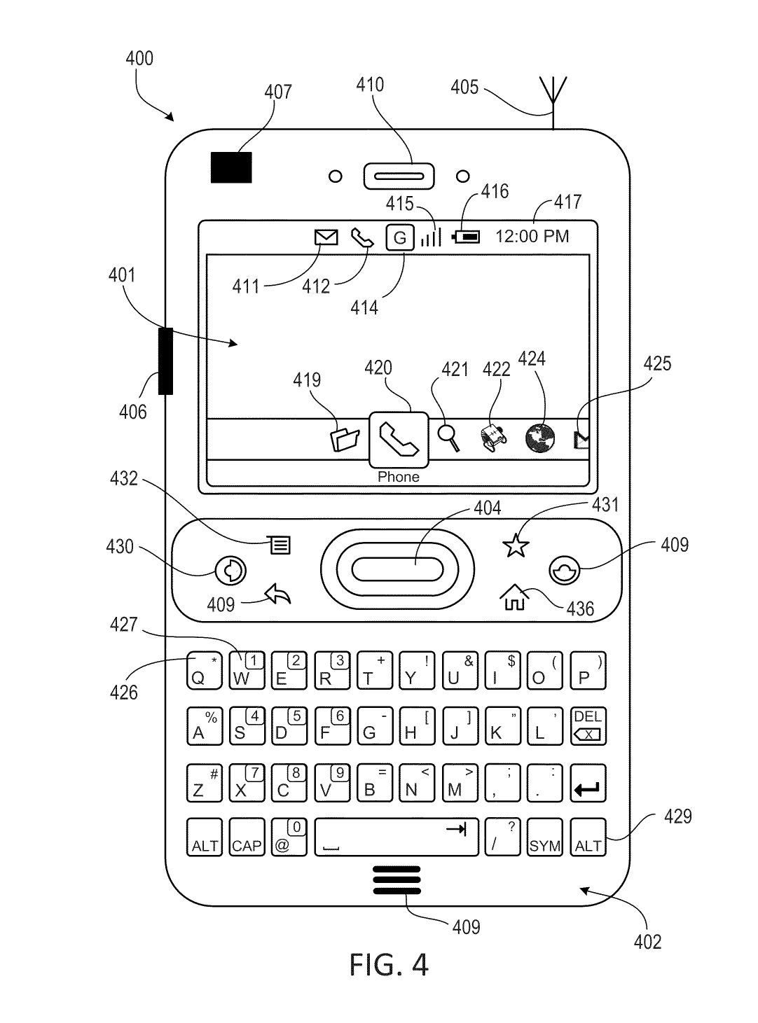

FIG. 4 shows a schematic representation of an example of a mobile device 400. Briefly, and among other things, the device 400 includes a processor configured to display information related to the usage of a resource, for example, the resource use display provided by a user interface module 260, upon request of a user of the mobile device.

In more detail, the hardware environment of the device 400 includes a display 401 for displaying text, images, and video to a user; a keyboard 402 for entering text data and user commands into the device 400; a pointing device 404 for pointing, selecting, and adjusting objects displayed on the display 401; an antenna 405; a network connection 406; a camera 407; a microphone 409; and a speaker 410. Although the device 400 shows an external antenna 405, the device 400 can include an internal antenna, which is not visible to the user.

The display 401 can display video, graphics, images, and text that make up the user interface for the software applications used by the device 400, and the operating system programs used to operate the device 400. Among the possible elements that may be displayed on the display 401 are a new mail indicator 411 that alerts a user to the presence of a new message; an active call indicator 412 that indicates that a telephone call is being received, placed, or is occurring; a data standard indicator 414 that indicates the data standard currently being used by the device 400 to transmit and receive data; a signal strength indicator 415 that indicates a measurement of the strength of a signal received by via the antenna 405, such as by using signal strength bars; a battery life indicator 416 that indicates a measurement of the remaining battery life; or a clock 417 that outputs the current time.

The display 401 may also show application icons representing various applications available to the user, such as a web browser application icon 419, a phone application icon 420, a search application icon 421, a contacts application icon 422, a mapping application icon 424, an email application icon 425, or other application icons. In one example implementation, the display 401 is a quarter video graphics array (QVGA) thin film transistor (TFT) liquid crystal display (LCD), capable of 16-bit or better color.

A user uses the keyboard (or “keypad”) 402 to enter commands and data to operate and control the operating system and applications to display or render the resource use display received from the user interface module 260. The keyboard 402 includes standard keyboard buttons or keys associated with alphanumeric characters, such as keys 426 and 427 that are associated with the alphanumeric characters “Q” and “W” when selected alone, or are associated with the characters “*” and “1” when pressed in combination with key 429. A single key may also be associated with special characters or functions, including unlabeled functions, based upon the state of the operating system or applications invoked by the operating system. For example, when an application calls for the input of a numeric character, a selection of the key 427 alone may cause a “1” to be input.

In addition to keys traditionally associated with an alphanumeric keypad, the keyboard 402 also includes other special function keys, such as an establish call key 430 that causes a received call to be answered or a new call to be originated; a terminate call key 431 that causes the termination of an active call; a drop down menu key 432 that causes a menu to appear within the display 401; a backward navigation key 434 that causes a previously accessed network address to be accessed again; a favorites key 435 that causes an active web page to be placed in a bookmarks folder of favorite sites, or causes a bookmarks folder to appear; a home page key 436 that causes an application invoked on the device 400 to navigate to a predetermined network address; or other keys that provide for multiple-way navigation, application selection, and power and volume control.

The user uses the pointing device 404 to select and adjust graphics and text objects displayed on the display 401 as part of the interaction with and control of the device 400 and the applications invoked on the device 400. The pointing device 404 is any appropriate type of pointing device, and may be a joystick, a trackball, a touch-pad, a camera, a voice input device, a touch screen device implemented in combination with the display 401, or any other input device.

The antenna 405, which can be an external antenna or an internal antenna, is a directional or omni-directional antenna used for the transmission and reception of radiofrequency (RF) signals that implement point-to-point radio communication, wireless local area network (LAN) communication, or location determination. The antenna 405 may facilitate point-to-point radio communication using the Specialized Mobile Radio (SMR), cellular, or Personal Communication Service (PCS) frequency bands, and may implement the transmission of data using any number or data standards. For example, the antenna 405 may allow data to be transmitted between the device 400 and a base station using technologies such as Wireless Broadband (WiBro), Worldwide Interoperability for Microwave ACCess (WiMAX), 3GPP Long Term Evolution (LTE), Ultra Mobile Broadband (UMB), High Performance Radio Metropolitan Network (HIPERMAN), iBurst or High Capacity Spatial Division Multiple Access (HC-SDMA), High Speed OFDM Packet Access (HSOPA), High-Speed Packet Access (HSPA), HSPA Evolution, HSPA+, High Speed Upload Packet Access (HSUPA), High Speed Downlink Packet Access (HSDPA), Generic Access Network (GAN), Time Division-Synchronous Code Division Multiple Access (TD-SCDMA), Evolution-Data Optimized (or Evolution-Data Only)(EVDO), Time Division-Code Division Multiple Access (TD-CDMA), Freedom Of Mobile Multimedia Access (FOMA), Universal Mobile Telecommunications System (UMTS), Wideband Code Division Multiple Access (W-CDMA), Enhanced Data rates for GSM Evolution (EDGE), Enhanced GPRS (EGPRS), Code Division Multiple Access-2000 (CDMA2000), Wideband Integrated Dispatch Enhanced Network (WiDEN), High-Speed Circuit-Switched Data (HSCSD), General Packet Radio Service (GPRS), Personal Handy-Phone System (PHS), Circuit Switched Data (CSD), Personal Digital Cellular (PDC), CDMAone, Digital Advanced Mobile Phone System (D-AMPS), Integrated Digital Enhanced Network (IDEN), Global System for Mobile communications (GSM), DataTAC, Mobitex, Cellular Digital Packet Data (CDPD), Hicap, Advanced Mobile Phone System (AMPS), Nordic Mobile Phone (NMP), Autoradiopuhelin (ARP), Autotel or Public Automated Land Mobile (PALM), Mobiltelefonisystem D (MTD), Offentlig Landmobil Telefoni (OLT), Advanced Mobile Telephone System (AMTS), Improved Mobile Telephone Service (IMTS), Mobile Telephone System (MTS), Push-To-Talk (PTT), or other technologies. Communication via W-CDMA, HSUPA, GSM, GPRS, and EDGE networks may occur, for example, using a QUALCOMM MSM7200A chipset with an QUALCOMM RTR6285™ transceiver and PM7540™ power management circuit.

The wireless or wired computer network connection 406 may be a modem connection, a local-area network (LAN) connection including the Ethernet, or a broadband wide-area network (WAN) connection such as a digital subscriber line (DSL), cable high-speed internet connection, dial-up connection, T-1 line, T-3 line, fiber optic connection, or satellite connection. The network connection 406 may connect to a LAN network, a corporate or government WAN network, the Internet, a telephone network, or other network. The network connection 406 uses a wired or wireless connector. Example wireless connectors include, for example, an INFRARED DATA ASSOCIATION (IrDA) wireless connector, a Wi-Fi wireless connector, an optical wireless connector, an INSTITUTE OF ELECTRICAL AND ELECTRONICS ENGINEERS (IEEE) Standard 802.11 wireless connector, a BLUETOOTH wireless connector (such as a BLUETOOTH version 1.2 or 3.0 connector), a near field communications (NFC) connector, an orthogonal frequency division multiplexing (OFDM) ultra wide band (UWB) wireless connector, a time-modulated ultra wide band (TM-UWB) wireless connector, or other wireless connector. Example wired connectors include, for example, a IEEE-1394 FIREWIRE connector, a Universal Serial Bus (USB) connector (including a mini-B USB interface connector), a serial port connector, a parallel port connector, or other wired connector. In another implementation, the functions of the network connection 406 and the antenna 405 are integrated into a single component.

The camera 407 allows the device 400 to capture digital images, and may be a scanner, a digital still camera, a digital video camera, other digital input device. In one example implementation, the camera 407 is a 3 mega-pixel (MP) camera that utilizes a complementary metal-oxide semiconductor (CMOS).

The microphone 409 allows the device 400 to capture sound, and may be an omni-directional microphone, a unidirectional microphone, a bi-directional microphone, a shotgun microphone, or other type of apparatus that converts sound to an electrical signal. The microphone 409 may be used to capture sound generated by a user, for example when the user is speaking to another user during a telephone call via the device 400. Conversely, the speaker 410 allows the device to convert an electrical signal into sound, such as a voice from another user generated by a telephone application program, or a ring tone generated from a ring tone application program. Furthermore, although the device 400 is illustrated in FIG. 4 as a handheld device, in further implementations the device 400 may be a laptop, a workstation, a midrange computer, a mainframe, an embedded system, telephone, desktop PC, a tablet computer, a PDA, or other type of computing device.

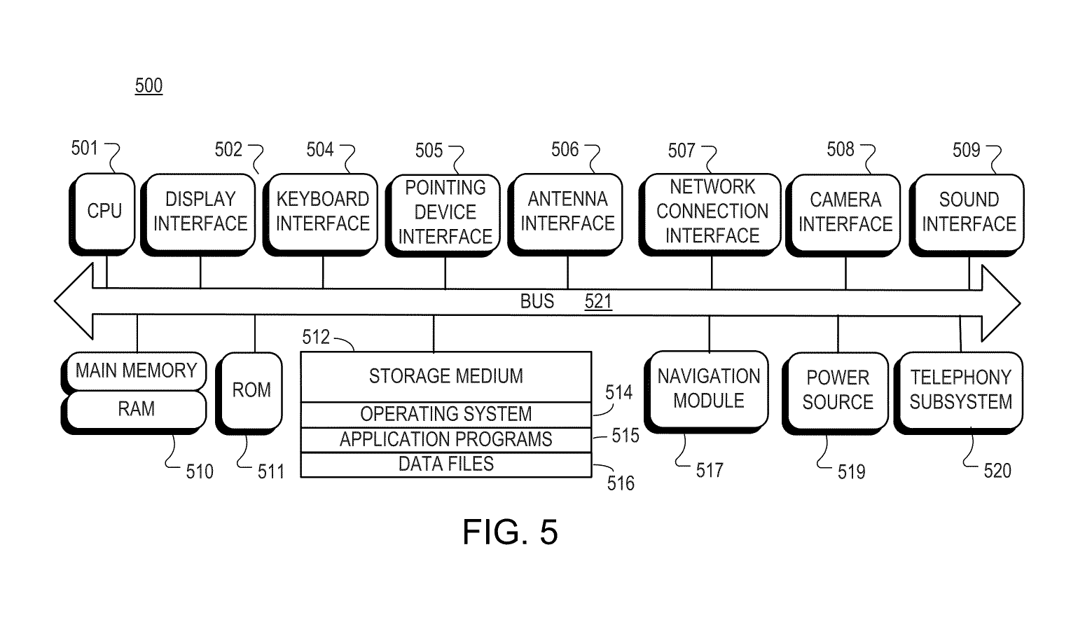

FIG. 5 is a block diagram illustrating an example of an internal architecture 500 of the device 400. The architecture includes a central processing unit (CPU) 501 where the computer instructions that comprise an operating system or an application are processed; a display interface 502 that provides a communication interface and processing functions for rendering video, graphics, images, and texts on the display 401, provides a set of built-in controls (such as buttons, text and lists), and supports diverse screen sizes; a keyboard interface 504 that provides a communication interface to the keyboard 402; a pointing device interface 505 that provides a communication interface to the pointing device 404; an antenna interface 506 that provides a communication interface to the antenna 405; a network connection interface 507 that provides a communication interface to a network over the computer network connection 406; a camera interface 508 that provides a communication interface and processing functions for capturing digital images from the camera 407; a sound interface 509 that provides a communication interface for converting sound into electrical signals using the microphone 409 and for converting electrical signals into sound using the speaker 410; a random access memory (RAM) 510 where computer instructions and data are stored in a volatile memory device for processing by the CPU 501; a read-only memory (ROM) 511 where invariant low-level systems code or data for basic system functions such as basic input and output (I/O), startup, or reception of keystrokes from the keyboard 402 are stored in a non-volatile memory device; a storage medium 512 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files that comprise an operating system 514, application programs 515 (including, for example, a web browser application, a widget or gadget engine, and or other applications, as necessary) and data files 516 are stored; a navigation module 517 that provides a real-world or relative position or geographic location of the device 400; a power source 519 that provides an appropriate alternating current (AC) or direct current (DC) to power components; and a telephony subsystem 520 that allows the device 400 to transmit and receive sound over a telephone network. The constituent devices and the CPU 501 communicate with each other over a bus 521.

The CPU 501 can be one of a number of computer processors. In one arrangement, the computer CPU 501 is more than one processing unit. The RAM 510 interfaces with the computer bus 521 so as to provide quick RAM storage to the CPU 501 during the execution of software programs such as the operating system application programs, and device drivers. More specifically, the CPU 501 loads computer-executable process steps from the storage medium 512 or other media into a field of the RAM 510 in order to execute software programs. Data is stored in the RAM 510, where the data is accessed by the computer CPU 501 during execution. In one example configuration, the device 400 includes at least 128 MB of RAM, and 256 MB of flash memory.

The storage medium 512 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 400 to access computer-executable process steps, application programs and the like, stored on removable and non-removable memory media, to off-load data from the device 400, or to upload data onto the device 400.

A computer program product is tangibly embodied in storage medium 512, a machine-readable storage medium. The computer program product includes instructions that, when read by a machine, operate to cause a data processing apparatus to store image data in the mobile device. In some embodiments, the computer program product includes instructions that generate an interface to receive resource usage data from a server.

The operating system 514 may be a LINUX-based operating system such as a mobile device platform; APPLE MAC OS X; MICROSOFT WINDOWS NT/WINDOWS 2000/WINDOWS XP/WINDOWS MOBILE; a variety of UNIX-flavored operating systems; or a proprietary operating system for computers or embedded systems. The application development platform or framework for the operating system 514 may be: BINARY RUNTIME ENVIRONMENT FOR WIRELESS (BREW); JAVA Platform, Micro Edition (JAVA ME) or JAVA 2 Platform, Java Platform Micro Edition (J2ME), JavaScript, ECMAScript, PYTHON™, FLASH LITE, or MICROSOFT .NET Compact, or another appropriate environment.

The device stores computer-executable code for the operating system 514, and the application programs 515 such as an email, instant messaging, a video service application, a mapping application, word processing, spreadsheet, presentation, gaming, mapping, web browsing, JAVASCRIPT engine, or other applications. For example, one implementation may allow a user to access the GMAIL email application, an instant messaging application, a video service application, a mapping application, or an imaging editing and presentation application. The application programs 515 may also include a widget or gadget engine, such as a TAFRI™ widget engine, a MICROSOFT gadget engine such as the WINDOWS SIDEBAR gadget engine or the KAPSULES™ gadget engine, a YAHOO! widget engine such as the KONFABULTOR™ widget engine, the APPLE DASHBOARD widget engine, a gadget engine, the KLIPFOLIO widget engine, an OPERA™ widget engine, the WIDSETS™ widget engine, a proprietary widget or gadget engine, or other widget or gadget engine the provides host system software for a physically-inspired applet on a desktop.

Although it is possible to render the resource use display using the above-described implementation, it is also possible to implement the functions according to the present disclosure as a dynamic link library (DLL), or as a plug-in to other application programs such as an Internet web-browser such as the FIREFOX web browser, the APPLE SAFARI web browser or the MICROSOFT INTERNET EXPLORER web browser.

The navigation module 517 may determine an absolute or relative position of the device, such as by using the Global Positioning System (GPS) signals, the GLObal NAvigation Satellite System (GLONASS), the Galileo positioning system, the Beidou Satellite Navigation and Positioning System, an inertial navigation system, a dead reckoning system, or by accessing address, internet protocol (IP) address, or location information in a database. The navigation module 517 may also be used to measure angular displacement, orientation, or velocity of the device 400, such as by using one or more accelerometers.

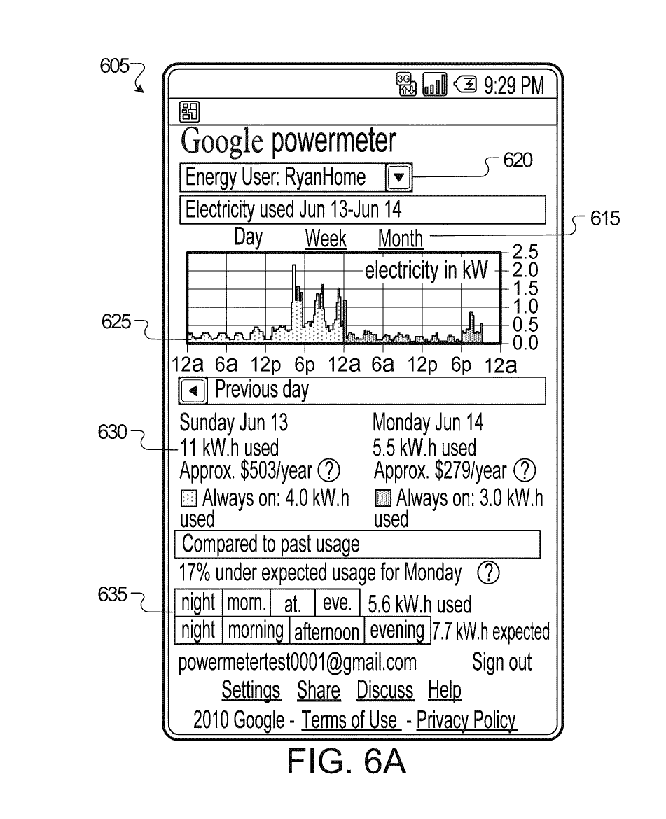

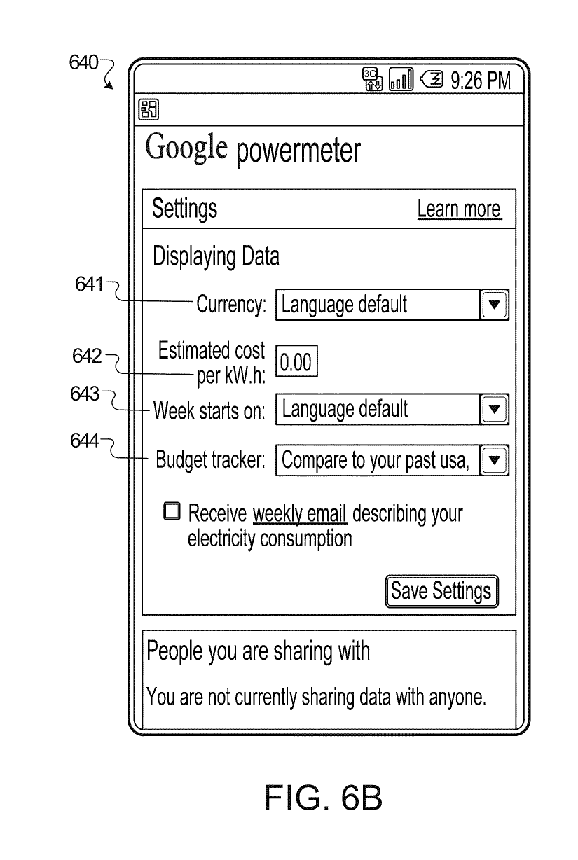

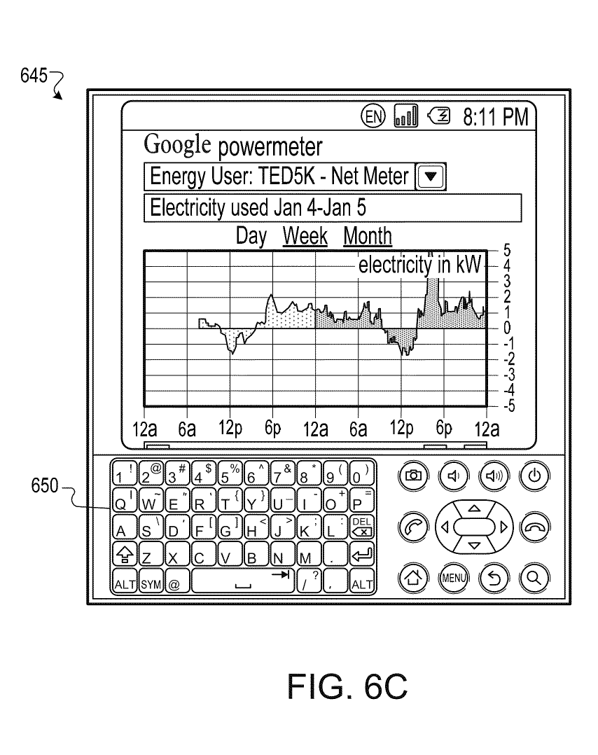

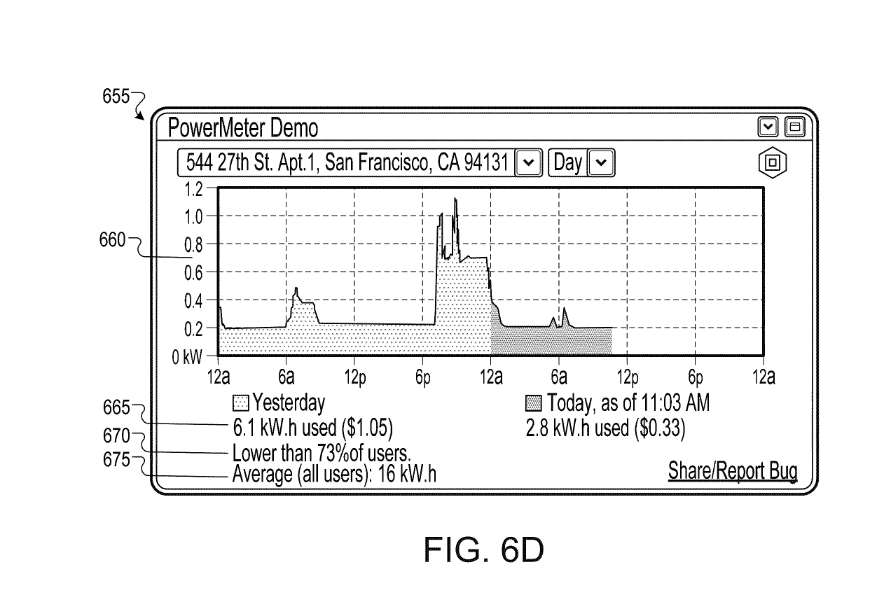

FIGS. 6A-6E show examples of user interfaces for resource monitoring on a mobile device. For example, FIG. 6A shows an example user interface 605 showing a plot 610 depicting electricity usage by a user during the course of two days. In this example, the data for the two separate days are distinguished using two different shades or colors. Hyperlinks 615 are provided to switch from a daily view to a weekly or monthly view. A dropdown menu allows the user to switch between multiple accounts (if any). The plot 610 also shows a baseline usage 625, i.e. a usage that is constant and due to devices that are always ON. The interface 605 also shows information 635 on a total consumption for the respective days and projected cost per year for the level of consumption. The interface 605 further includes a comparison indicator 635 that compares the current use to that of past usage. In this example, the comparison indicator indicates that the current usage (for Monday, June 14) is 17% below the expected usage for Mondays, based on past data. The expected usage and current usage may also be shown broken down in terms of the time of the day. Such detailed analysis allows a user to identify usage patterns and possibly take corrective steps to reduce energy consumption.

FIG. 6B shows an example interface 640 through which a user can enter account or display preferences. In this example, the interface includes input mechanisms so that a user can choose parameters such as currency 641, estimated cost per unit 642, time frames 643 and budget tracker 644. The interface 640 also allows a user to view and edit the list of people with whom the user is sharing the consumption data. In some implementations, the preferences can be input using a “soft” keyboard that is presented as a part of the user interface. Such a soft keyboard 650 is shown in the user interface example 645 in FIG. 6C.

FIG. 6D shows another example user interface 655 that, in addition to daily usage data 660 and usage indicator data 665, shows a comparison indicator 670 relative to other users. As shown in the example, the comparison indicator 670 indicates that the user's resource usage during the previous day was lower than 73% of the other users that track their usage using the system that provided the interface. The interface 655 also shows a statistic 675, an average in this example, calculated from the data of the other users.

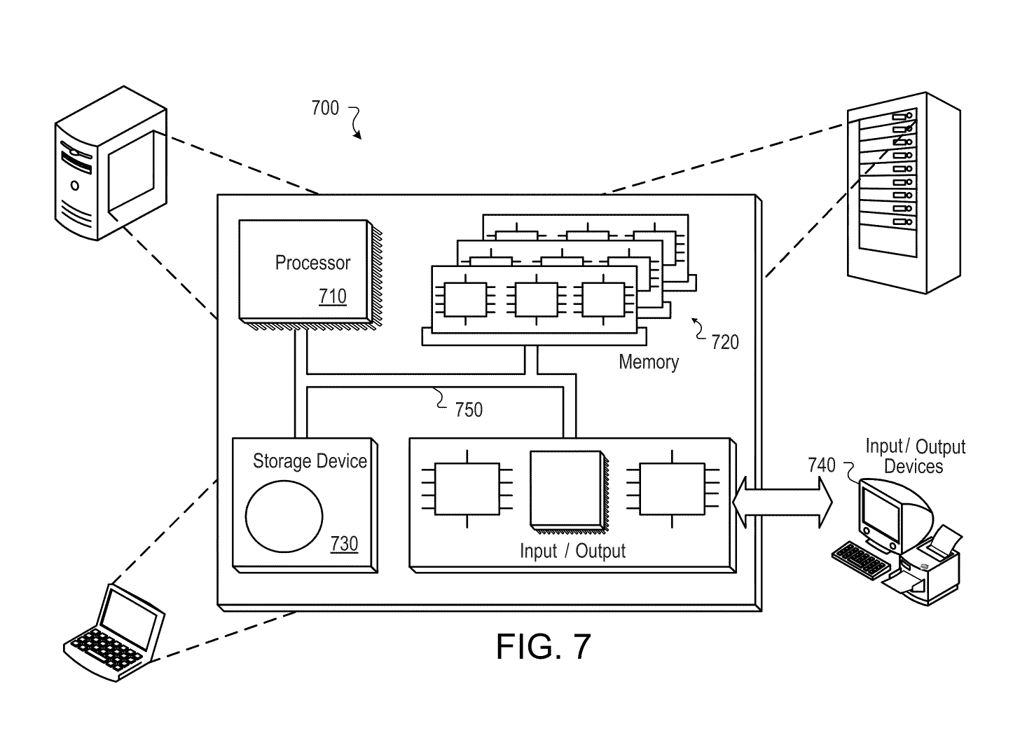

FIG. 7 is a block diagram of computing device 700 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

FIG. 7 is a schematic diagram of a computer system 700. The system 700 can be used for the operations described in association with any of the computer-implemented methods described herein, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 can include volatile memory and/or non-volatile memory.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, or in combinations of them. The features can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

The processor 710 carries out instructions related to a computer program. The processor 710 may include hardware such as logic gates, adders, multipliers and counters. The processor 710 may further include a separate arithmetic logic unit (ALU) that performs arithmetic and logical operations.

A number of implementations have been described. Nevertheless, it will be understood that various modifications may be made. For example, various forms of the flow shown above may be used, with steps re-ordered, added, or removed. Also, although several applications of resource monitoring systems and methods have been described, it should be recognized that numerous other applications are contemplated. For example, any resource that can be measured using a smart meter, can be monitored remotely using a mobile device without departing from the scope of the present application. Accordingly, other embodiments are within the scope of the following claims.

What is claimed is:

1. A method comprising:
accessing, at a server system, a first set of data reflecting usage of a resource at a first user's premises, wherein the first set of data is based on readings from a metering device located at the first user's premises, the server system being located at a location that is different than a location of the first user's premises;
accessing, at the server system, a second set of data reflecting usage of the resource at multiple user premises, the multiple user premises not including the first user's premises;
generating, at the server system and based on the first set of data and the second set of data, a comparison indicator that reflects the usage of the resource at the first user's premises over a period of time relative to the usage of the resource at the multiple user premises over the same period of time;
generating, at the server system and based on the first set of data, a usage indicator reflecting the usage of the resource at the first user's premises over the period of time; and
sending, from the server system and to a mobile device, the comparison indicator and the usage indicator such that the mobile device displays the comparison indicator and the usage indicator.

2. The method of claim 1 wherein the readings from the metering device located at the first user's premises comprise periodic readings of a quantity of the resource consumed at the first user's premises.

3. The method of claim 2 further comprising processing the first set of data to generate one or more indications of a quantity of the resource consumed between the periodic readings.

4. The method of claim 3 wherein processing the first set of data includes interpolating between the periodic readings to generate the one or more indications.

5. The method of claim 1 wherein the second set of data is based on readings from metering devices located at the multiple user premises.

6. The method of claim 5 wherein the multiple user premises are located within a defined geographic area.

7. The method of claim 6 wherein the multiple user premises are located with the same zip code.

8. The method of claim 1 wherein the metering device is installed and operated by the first user.

9. The method of claim 1 wherein the metering device is installed and operated by a company providing the resource to the first user's premises.

10. The method of claim 1 further comprising:
calculating, by the server based on the first data, a baseline usage of the resource; and
sending a representation of the baseline to the mobile device such that the mobile device displays the baseline.

11. The method of claim 1, further comprising:
receiving, at the server system and from the mobile device, a total target amount of usage of the resource at the first user's premises over a predetermined future time period, wherein the total target amount of usage was selected by the user using an interface of the mobile device;
tracking, by the server, an actual usage of the resource at the first user's premises over a portion of the predetermined time period;
generating a goal indicator that reflects a comparison of the actual usage to the total target amount of usage; and
sending the goal indicator to the mobile device such that the mobile device displays the goal indicator.

12. The method of claim 11, further comprising:
receiving, at the server system, information identifying a group of users selected by the first user, wherein the selection is made using the interface of the mobile device, and the total target amount of usage is a predetermined percentage of a representative usage of the resource at the selected users' premises over a time period substantially equal to the predetermined future time period.

13. The method of claim 1 wherein the resource is electricity.

14. The method of claim 1 further comprising:
receiving, at the server system, information identifying a first group of users selected by the first user using an interface on the mobile device; and
using data on usage of the resource at the premises of the selected group of users as the second set of data.

15. The method of claim 15 further comprising:
receiving, at the server system, information identifying a second group of users selected by the first user using the interface on the mobile device;
accessing, at the server system, a third set of data reflecting usage of the resource at user premises for the second group of users;
generating, at the server system and based on the first set of data and the third set of data, an updated comparison indicator that reflects the usage of the resource at the first user's premises over a period of time relative to the usage of the resource at the user premises for the second group of users over the same period of time; and
sending, from the server system and to the mobile device, the updated comparison indicator such that the mobile device displays the updated comparison indicator and the usage indicator.

16. The method of claim 1 wherein the server system is operated by a third party independent from a utility company providing the resource, and accessing, at a server system, the first set of data reflecting usage of a resource at a first user's premises comprises receiving the first set of data from the utility company.

17. The method of claim 1 wherein the server system is operated by a third party independent from a utility company providing the resource, and accessing, at a server system, the first set of data reflecting usage of a resource at a first user's premises comprises receiving the first set of data directly from the metering device located at the first user's premises.

18. A computer-readable medium storing a computer program comprising instructions that, when executed by one or more processing devices, cause the one or more processing devices to:
access a first set of data reflecting usage of a resource at a first user's premises, wherein the first set of data is based on readings from a metering device located at the first user's premises, the one or more processing devices being located at a location that is different than a location of the first user's premises;
access a second set of data reflecting usage of the resource at multiple user premises, the multiple user premises not including the first user's premises;
generate, based on the first set of data and the second set of data, a comparison indicator that reflects the usage of the resource at the first user's premises over a period of time relative to the usage of the resource at the multiple user premises over the same period of time;
generate, based on the first set of data, a usage indicator reflecting the usage of the resource at the first user's premises over the period of time; and
send, to a mobile device, the comparison indicator and the usage indicator such that the mobile device displays the comparison indicator and the usage indicator.

19. A system comprising:
a server system configured to:
access a first set of data reflecting usage of a resource at a first user's premises, wherein the first set of data is based on readings from a metering device located at the first user's premises, the server system being located at a location that is different than a location of the first user's premises,
access a second set of data reflecting usage of the resource at multiple user premises, the multiple user premises not including the first user's premises,
generate, based on the first set of data and the second set of data, a comparison indicator that reflects the usage of the resource at the first user's premises over a period of time relative to the usage of the resource at the multiple user premises over the same period of time, and
generate, based on the first set of data, a usage indicator reflecting the usage of the resource at the first user's premises over the period of time; and
a mobile device configured to:
receive the comparison indicator and the usage indicator, transmitted by the server, and
display the comparison indicator and the usage indicator.

20. The system of claim 18 wherein the mobile device is further configured to accept from the first user, via a user interface, information identifying a group of users such that usage data of the resource at premises of the group of users is used as the second set of data.

21. The system of claim 20 wherein:
the mobile device is further configured to accept from the first user, via a user interface, information identifying a second group of users selected by the first user and send an indication of the second group of users to the server system; and
the server system is further configured to:
access a third set of data reflecting usage of the resource at user premises for the second group of users;
generate, based on the first set of data and the third set of data, an updated comparison indicator that reflects the usage of the resource at the first user's premises over a period of time relative to the usage of the resource at the user premises for the second group of users over the same period of time; and
send, to the mobile device, the updated comparison indicator such that the mobile device displays the updated comparison indicator and the usage indicator.

22. The system of claim 18 wherein the mobile device is further configured to accept, from the first user, via a user interface, a total target amount of usage of the resource at the first user's premises over a predetermined future time period.

23. The system of claim 20 wherein the mobile device is further configured to accept from the first user, via a user interface, information identifying a group of users such that the total target amount of usage is a predetermined percentage of a representative usage of the resource at premises of the group of users.
